(19) United States
(12) Patent Application Publication
(10) Pub. No.: US 2010/0302537 A1
(43) Pub. Date: Dec. 2, 2010

(54) SPECTROSCOPY DEVICE AND METHOD FOR ITS IMPLEMENTATION

(75) Inventors: Fabien Chauchard, Prades Le Lez (FR); Sylvie Roussel, Prades Le Lez (FR)

Correspondence Address: THE NATH LAW GROUP, 112 South West Street, Alexandria, VA, 22314, US

(73) Assignee: INDATECH, Prades Le Lez (FR)

(21) Appl. No.: 12/695,551

(22) Filed: Jan. 28, 2010

(30) Foreign Application Priority Data
May 28, 2009 (FR) 09 53521

(51) Int. Cl. G01J 3/30

(52) U.S. Cl. 356/317

(57) ABSTRACT

The invention relates to a spectroscopy device (1) for analyzing a sample (E) and including at least one spectroscopic probe (2) provided with:
means for illuminating the sample (E);
means for collecting light re-emitted by the sample (E);
a contact surface (22) oriented towards the sample (E), at the level of or near which (22) the illuminating means and/or the collecting means are located and including at least a means (26a; 26b) for receiving the re-emitted light.

This device (1) is characterized in that:
the probe (2) includes at least two different receiving means (26a; 26b) having, each (26a; 26b), a index absorption, reflection and/or diffusion different, and each (26a; 26b) associated to at least part of the collecting means and/or;
the device (1) includes an element (5) interposed between the contact surface (22) and the sample (E) to be analyzed, and designed to diffuse at least the incident light.

### BACKGROUND OF THE INVENTION

(1) Field of the Invention

The present invention relates to a spectroscopy device for analyzing a sample and at least partially formed by a spectroscopic probe. This invention also relates to a method for analyzing such a sample by spectroscopy, during which such a spectroscopy device is used.

This invention is related to the field of the manufacture of the devices permitting to carry out an analysis of a sample by spectroscopy.

In this respect, it should be noted that spectroscopy is a technique largely implemented in industry and research when samples have to be characterized.

(2) Description of the Prior Art

In fact, various types of spectroscopy are known, each of these types, on the one hand, corresponding substantially to a range of wavelengths of the light emitted (UV, visible, near infrared) and, on the other hand, permitting to characterize in particular some of these samples.

Thus, when a sample has to be characterized by spectroscopy, a (generally polychromatic) light source is used to illuminate this sample by photons, a part of which penetrate into this sample and interacts with the medium of this sample.

In this respect, it should be noted that the interactions between these photons and the medium of the sample can be of three types, namely:

by light absorption, such an absorption depending on the frequency and the type of chemical molecules contained in the medium of the sample;

by light diffusion, such a diffusion depending on the physical matrix of the sample, i.e. of the heterogeneity of the medium of the sample (particles, fibers, cells, turbidity . . . );

by fluorescence, depending primarily on the chemicals the medium of the sample includes.

This spectroscopic technique permits in particular to analyze a sample interacting with the light primarily by absorption of the latter.

This is for example the case of a homogeneous sample such as a non-turbid liquid.

In such a case, it is possible to determine the properties of such a sample by relating the intensity of the signal measured at the exit of the sample to the chemical concentration of the chemical compounds contained in this sample. This requires however a good knowledge of the spectral characteristics of the light source, in particular of the light intensity Io of this light source.

In this way it is possible to determine the concentration of the sample, in particular by applying the Beer law, even (and mostly) by PLS modeling (method of partial least squares).

However, when the sample is particularly absorbent (such as bitumen, carbon, black plastic, coal, graphite, petroleum or the like), the signal obtained by spectroscopy is too noisy to obtain useful and utilizable information.

Likewise, when the sample includes a plurality of layers, the spectrum obtained by spectroscopy corresponds to the average of the chemical compounds these various layers are comprised of, without it being possible to characterize each of these layers individually.

Finally, in the field of agro-food or pharmacy, the samples are often comprised of a mixture of granular products or multi-phase liquids (such as for example flour, powder, pharmaceutical pills or the like). Such a mixture is often non-homogenous and it is not possible to determine or to characterize the homogeneity of this mixture by means of a spectroscopic technique of this type.

It should be noted that the samples interacting with the light primarily by absorption are, as a matter of fact, a minority of the samples that have to be analyzed, namely by spectroscopy. In fact, most of the samples interact with the light by absorption, but also by diffusion, so that the spectrum obtained by spectroscopy corresponds to two variables. One of these variables is related to the absorption and is characterized by an absorption coefficient μa. The other variable is related to the diffusion and is characterized by a diffusion coefficient μs′.

The spectrum obtained by spectroscopy takes into consideration this diffusion coefficient μs′ and this absorption coefficient μa and constitutes in fact a combination of these coefficients. This combination is characterized by a simplified analytical equation:

$$\begin{matrix}R ( ρ ) = {I}_{0} {z}_{0} \frac{exp ( - {μ}_{eff} ρ )}{2 {πρ}^{2}} ( {μ}_{eff} + \frac{1}{ρ} ) \\ = {I}_{0} {z}_{0} f ( {μ}_{eff} , ρ )\end{matrix} \qquad ( 1 )$$

in which z0=1/μs′, I₀ is the intensity of the light source in the medium, ρ is the distance with respect to the radiation source and μeff is a non-linear combination of μa and μs′:

μ_{eff}=\sqrt{3μₐ(μₐ+μ′ₛ)} (2)

Within the framework of an analysis by traditional spectroscopy (UV, visible, near infrared), the physical and chemical information should be separated while ensuring a processing of the spectrum aiming primarily at eliminating part of the diffusion effect, this before looking for a look-ahead model permitting to predict the value of the characteristic looked for.

This approach has however a first disadvantage consisting in that the diffusion effect is not completely eliminated by the processing of the spectrum, so that the look-ahead model remains sensitive to the physical changes of the sample (lack of robustness of the mathematical model), which results into it being prejudicial to the precision of prediction of the model.

This approach also has a second disadvantage related to the weak separation between physical information and chemical information, preventing a sufficient or satisfactory utilization of the physical information. In particular, it is not possible to use the diffusion coefficient to predict the particle size or the density of the sample.

Finally, this approach permits to obtain only one single spectrum, which does not permit at all to measure the homogeneity of the sample to be analyzed.

These disadvantages have been coped with by the technique of spatially resolved spectroscopy (SRS) consisting in adding a dimension to the spectral data and thus permitting to separate the diffusion coefficients.

In fact, this technique (SRS) consists in measuring spectra at various distances from the light source, which permits to obtain an optical signal depending both on the wavelength and on the distance (space-time 2D signal). By solving the equation of the diffusion (by an inverse Montecarlo simulation or by an inverse Levenbert Marquart method) it is possible to determine the diffusion coefficient μs′ and the absorption coefficient μa.

This technique is particularly efficient, but has the disadvantages, on the one hand, of requiring several minutes to obtain the diffusion coefficient μs′ and the absorption coefficient μa and, on the other hand, of having to perfectly know the intensity Io of the light source.

Another disadvantage of this technique resides in that it does not permit to determine the homogeneity of a sample.

The international patent application WO2007/119005 relates to a spectroscopy device permitting to avoid the problem of the knowledge of the intensity Io of the light source. In this document is described a spectroscopy device as well as a method for analyzing implementing this device. This method consists, on the one hand, in injecting light into a sample at a first point of this sample, on the other hand, in taking light at a second point of the sample and, yet on the other hand, in re-injecting the light taken at a third point of this sample away from the taking point.

However, the spectroscopy device permitting to implement the method has the disadvantage of including a probe with a large measuring diameter, a plurality of fibers as well as a plurality of mirrors.

### SUMMARY OF THE INVENTION

The present invention pretends to be capable of coping with the disadvantages of the state-of-the-art devices and methods.

To this end, the invention relates to a spectroscopy device for analyzing a sample by spectroscopy and including at least one spectroscopic probe provided with:

means for illuminating the sample to be analyzed with incident light;

means for collecting light re-emitted by the sample to be analyzed under the action of the incident light;

a contact surface, on the one hand, oriented towards the sample to be analyzed, on the other hand, at the level of or near which the illuminating means and/or the collecting means are located and, yet on the other hand, including at least one means for receiving the light re-emitted by the sample.

This spectroscopy device is characterized in that:

the probe includes at least two different receiving means, on the one hand, which the contact surface includes, on the other hand, having each a different absorption, reflection and/or diffusion index and, yet on the one hand, each associated to at least part of the collecting means, and/or;

the device also includes an element interposed between the contact surface and the sample to be analyzed, and designed to diffuse at least the incident light (even the re-emitted light).

The invention also relates to a method for analyzing a sample by spectroscopy consisting in that:

the sample is illuminated with incident light and by means of at least one illuminating means;

the light re-emitted by the sample is received by means of at least one receiving means;

the light re-emitted by the sample is collected by collecting means, this at the level of or near receiving means.

This method is characterized in that:

the sample is illuminated with incident light, this through a diffusing element and/or;

the light re-emitted by the sample is collected at the level of at least two different receiving means, which each, on the one hand, have a different absorption, reflection and/or diffusion index and, on the other hand, receive, at its level or close to it, at least part of the collecting means;

at least one property of the sample to be analyzed is determined based on the light re-emitted and collected by the collecting means, this at the level of this or these receiving means.

The advantages of this invention consist, compared to the spatially resolved spectroscopy (SRS) technique generating a two-dimensional signal (depending on the distance and the wavelength) capable of allowing solving an equation with two unknown quantities, in generating a third spectral measurement dimension permitting advantageously to determine the intensity Io of the light source.

Another advantage consists in that the device according to the invention can include a diffusing element interposed between the probe and the sample. This diffusing element acts as a light amplifier and advantageously permits to illuminate the sample over a large surface (larger than that of the illuminating means the probe includes).

As an alternative or in addition to such a diffusing element, the device includes a probe provided with at least two different receiving means. These receiving means, on the one hand, have, each, a different absorption, reflection and/or diffusion index and, on the other hand, are each associated to part of the collecting means.

The presence of these various receiving means permits to measure the spectral signal in areas having a different index (in particular at the boundaries), which in fact permits to measure, for a same sample, the changes of a spectral signal with respect to the changes caused by the differences in optical properties of these areas with different reflecting (absorbing and/or diffusing) characteristics.

It is in particular such a type of measurement that permits to generate the above-mentioned third dimension, which advantageously permits to determine the intensity Io of the light source as well as the absorption coefficient μa and the diffusion coefficient μs′.

Another advantage consists in that this type of measurement permits to detect the presence of layers in a sample, but also the fluorescence (in particular by simulations of finite elements in 3D, this taking into consideration the particular geometry of the probe).

It should also be noted that by collecting the light re-emitted at points located at different distances from the light source, the intensity Io of this light source as well as the absorption coefficient μa and the diffusion coefficient μs′ can advantageously be determined.

On the other hand, by collecting the light re-emitted at points located at the same distance from the light source (for example on a circle centered with respect to this light source), the homogeneity of a mixture forming the sample to be analyzed can advantageously be determined.

Finally, the measurements performed under different optical conditions permit to substantially improve the quality of the signal.

Further objectives and advantages of this invention will become clear during the following description referring to embodiments that are given only by way of indicative and non-restrictive examples.

### BRIEF DESCRIPTION OF THE DRAWINGS

This description will be better understood when referring to the attached drawings, in which:

FIG. 1 is a schematic view of a spectroscopy device according to the present invention;

FIG. 2 is a schematic and longitudinal cross-sectional view of the free end of a probe the spectroscopy device shown in FIG. 1 includes;

FIG. 3 is a schematic and front view of the free end of the probe shown in FIGS. 1 and 2;

FIG. 4 is a schematic view of the cooperation of a probe of the invention, according to a first embodiment, with a sample to be analyzed, this through a diffusing element;

FIG. 5 is a schematic view of the cooperation of a probe of the invention, according to a second embodiment, directly with the sample to be analyzed;

FIG. 6 is a schematic view of the cooperation of a probe of the invention, according to the second embodiment, with a sample to be analyzed, this through a diffusing element.

### DETAILED DESCRIPTION OF THE PREFERRED EMBODIMENTS

The invention is related to the field of the manufacture of the devices permitting to carry out an analysis of a sample E by spectroscopy.

Such a spectroscopy device 1 includes, on the one hand, a spectroscopy probe 2, on the other hand, means 3 for measuring and/or processing the optical signal re-emitted by the sample E and, yet on the other hand, means 4 for connecting said probe 2 to this means 3 for measuring and/or processing.

As regards said spectroscopy probe 2, it adopts a shape as well as dimensions permitting, as the case may be, an easy gripping by an operator entrusted with the analysis of the sample E or its mounting onto a support an installation for analyzing, producing or conveying such a sample E includes.

In particular, such a probe 2 can adopt the shape of a tube having, on the one hand, a preferably circular cross-section, on the other hand, a length ranging from 100 to 800 mm (preferably in the range of about 200 to 600 mm) and, yet on the other hand, an outer diameter ranging from 5 mm to 35 mm (preferably in the range of about 15 mm).

This probe 2 includes, on the one hand, a first end 20 at the level of which this probe 2 is connected to the spectrometer through the connecting means 4 and, on the other hand, a second end 21 (referred to as free end) provided with a contact surface 22, aimed at being oriented towards the sample E to be analyzed, and through which this probe 2 cooperates with the sample E that has to be analyzed.

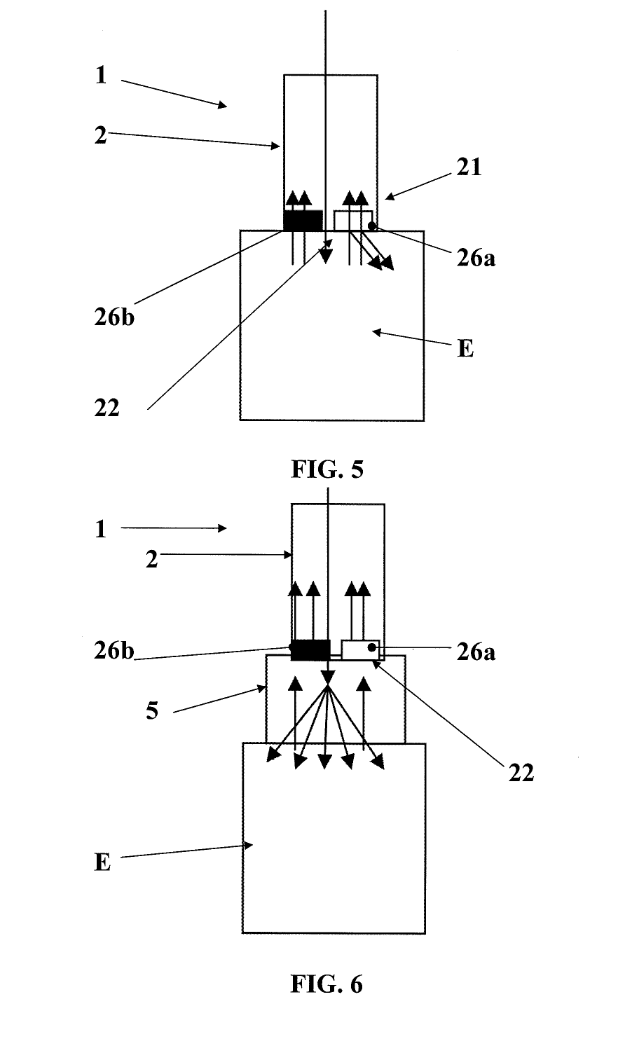

In this respect, it should be noted that the contact surface 22 of this probe 2 can cooperate directly with this sample E, in particular through direct contact between this contact surface 22 and this sample E, as shown in FIG. 5.

However, this contact surface 22 can also cooperate indirectly with this sample E, in particular through an intermediate element interposed between this contact surface 22 and this sample E. Such an intermediate element can consist of a measuring window (made of glass, quartz, sapphire or the like), on the one hand, before which this contact surface 22 is positioned, on the other hand, behind which the sample E is located and, yet on the other hand, namely a unit for transporting or manufacturing this sample E includes.

Such an intermediate element can also consist of a diffusing element 5, as will be described below.

Another feature of this contact surface 22 consists in that it extends in a direction forming a determined angle with the general direction of extension of the probe 2 (in particular with respect to the axis of the tube this probe 2 includes).

According to a first embodiment, not shown, this contact surface 22 extends in a direction forming an angle ranging from 35 to 55° (preferably 45°) with respect to the direction of the axis of the tube.

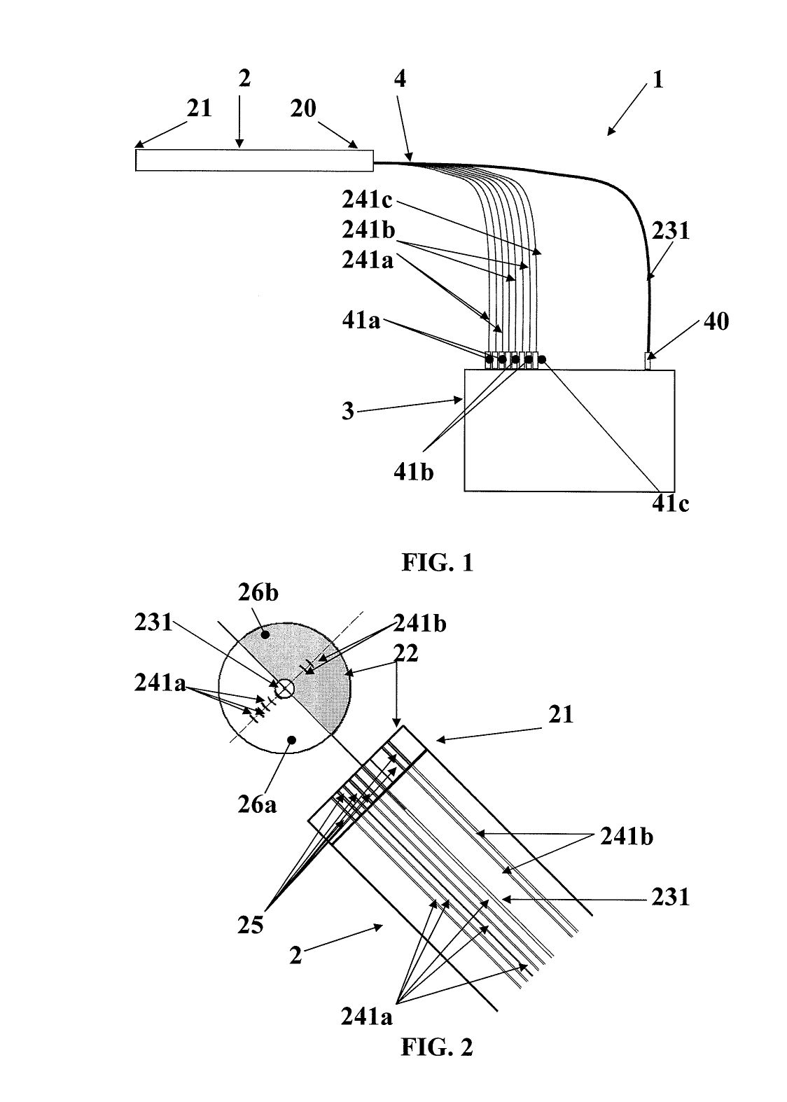

However and as can be seen in FIGS. 1 and 2, this contact surface 22 preferably extends substantially perpendicular to the axis of this tube.

Another feature of this spectroscopy probe 2 consists in that it includes means 23 for illuminating the sample E to be analyzed with incident light.

Such illuminating means 23 include at least one optical fiber 230 or a plurality of optical fibers 230, in particular grouped within at least one bundle 231 of optical fibers 230.

These illuminating means 23 are located at the level of or near the contact surface 22 the probe 2 includes.

Another feature of the spectroscopy probe 2 consists in that it includes means 24 for collecting light re-emitted by the sample E to be analyzed under the action of incident light.

Such collecting means 24 include, here too, at least one optical fiber 240 or a plurality of optical fibers (240a; 240b; 240c), in particular grouped within at least one series (241a; 241b; 241c) of optical fibers (240a; 240b; 240c).

These collecting means 24 are, here too, located at the level of or near the contact surface 22 the probe 2 includes.

An additional feature consists in that the probe 2 includes at least one through opening 25 provided for in the wall of this probe 2, in particular in the wall at the level of which the contact surface 22 of the probe 2 is defined.

In fact, such a through opening 25 ends at the level of this contact surface 22 and is intended to receive, internally, at least one illuminating means 23 or at least one collecting means 24 (in particular at least one optical fiber such illuminating 23 or collecting 24 means includes), the end of which is preferably positioned substantially flush with this contact surface 22.

It should be noted that, in the case of illuminating means 23 and/or collecting means 24 formed of a series (231; 241a; 241b; 241c) of optical fibers (230; 240a; 240b; 240c), in particular positioned juxtaposed, such a through opening 25 can consist of a slit provided for in the wall of the probe 2 at the level of which the contact surface 22 is defined.

Finally and as regards this contact surface 22, it also includes at least one means (26, 26a; 26b) for receiving the light re-emitted by the sample E.

According to the invention, the spectroscopy device 1 can also include an element 5 interposed between the contact surface 22 and the sample E and designed so as to diffuse at least the incident light (even also the light re-emitted by the sample E).

Such a diffusing element 5 can be either independent from the probe 2 (in particular in the form of a movable component positioned at the surface of the sample and with respect to which the probe 2 moves) or associated to this probe 2. The latter 2 can then include means for mounting and/or receiving (in particular removably) such a diffusing element 5.

Such a diffusing element 5 advantageously permits to illuminate this sample E in a diffuse way and over a large surface, in particular over a surface the extent of which is clearly larger than that of the contact surface 22 of the probe 2.

The use of such a diffusing element 5 then advantageously permits to analyze very absorbent samples E (as for example a bitumen, graphite, a paint, coal . . . ) or very diffusing samples E (such as for example a powder product, in particular a powder, flour . . . ).

In FIGS. 4 and 6 are shown two embodiments of a spectroscopy device 1 including such a diffusing element 5.

In particular, in FIG. 4 is shown a spectroscopy device 1 including such a diffusing element 5 as well as one single receiving means 26 the probe 2 of this device 1 includes, and which is defined at the level of at least part of the contact surface 22 of this probe 2.

Preferably, such receiving means 26 is defined at the level of the whole contact surface 22 of this probe 2, namely defined by this contact surface 22 itself.

In this respect, it should be noted that such receiving means 26 is characterized by a particular aspect (reflecting, absorbent, diffusing, mat, glossy, colored . . . ) of the contact surface 22 providing this contact surface 22 with a particular absorption, reflection and/or diffusion index.

Thus and according to a first embodiment, such receiving means 26 is of a reflecting type and is defined at the level of at least part of the (preferably at the level of the whole) contact surface 22.

According to a preferred embodiment of the invention, such receiving means 26 of a reflecting type can then consist of at least one polished or white portion of the contact surface 22 of the probe 2 (preferably the whole of this contact surface 22), in particular of a polished or white portion of material this probe 2 is formed of at the level of this contact surface 22 (which is, in the case of a polished portion, preferably made of stainless steel).

However and according to another embodiment, such receiving means 26 can also consist of a reflecting coating (of polished or white aspect) at least one portion of the (preferably the entire) contact surface 22 includes.

Such a reflecting coating is then applied on the material the probe 2 is formed of at the level of this contact surface 22.

According to a second embodiment, such receiving means 26 is of an absorbing type and is defined at the level of at least one portion of the (preferably at the level of the entire) contact surface 22.

In this respect, it should be noted that such receiving means 26 can then consist of a colored material forming at least one portion of the contact surface 22, in particular of a colored material forming said probe 2 at least at the level of this contact surface 22 (material the probe 2 is formed of).

However, such receiving means 26 can also consist of a colored coating at least one portion of the (preferably the entire) contact surface 22 includes. Such a colored coating can then be applied to the material the probe 2 is formed of at the level of this contact surface 22.

Finally, a third embodiment consists in that the receiving means 26 is of a diffusing type and is defined at the level of at least one portion of the (preferably at the level of the entire) contact surface 22.

Such receiving means 26 of a diffusing type can then consist of a surface condition having asperities (ribs, grooves, granular aspect . . . ) and at least one portion of the (preferably the entire) contact surface 22 includes.

Such a surface condition can be provided by a surface treatment (physical and/or chemical treatment, by adequate polishing, abrasion, erosion, making of asperities, grooves, ribs, grains . . . of the probe 2, in particular of the material this probe 2 is formed of at the level of this contact surface 22.

However, such a diffusing-type receiving means 26 can also consist of a diffusing coating at least one portion of the (preferably the entire) contact surface 22 includes. Such a diffusing coating can then be applied on the material the probe 2 is formed of at the level of this contact surface 22.

As mentioned above, a receiving means 26 can consist of a coating (reflecting, absorbent or diffusing, as the case may be) the contact surface 22 includes, which can then consist of a chemical and/or physical deposition, a paint, a film, a polymer layer or the like.

A particular embodiment consists in fact in that an absorbing-type coating (or respectively a reflecting coating in the form of a white portion) can then consist of a black (or respectively white) paint applied to the material the probe 2 is formed of at the level of this contact surface 22.

According to the invention, the probe 2 of this spectroscopy device 1 can also include at least two different receiving means (26a; 26b), on the one hand, the contact surface 22 of the probe 2 includes, on the other hand, each (26a; 26b), having a different absorption, reflection and/or diffusion index and, yet on the other hand, each (26a; 26b) associated to at least part of the collecting means 24, even at least part of the illuminating means 23.

In fact, these different receiving means (26a; 26b) have each a different absorption, reflection and/or diffusion index, this in order to provide this probe 2 with at least two areas (each one related to such a receiving means 26a; 26b) having, each, different optical characteristics (in terms of reflection, absorption and/or diffusion) permitting to provide different optical properties to the light re-emitted by the sample E, received by each of these receiving means (26a; 26b), and collected at the level (in particular at the limits) of such a reflecting means (26a; 26b) by the collecting means 24.

According to a first embodiment shown in FIG. 5, the probe 2 includes at least two of these receiving means (26a; 26b) at the level of the contact surface 22 which cooperates directly with the sample E. In this embodiment, the spectroscopy device 1 is without any diffusing element 5 whatsoever.

However and according to another embodiment shown in FIG. 6, such a spectroscopy device 1 includes (at the level of the contact surface 22 of the probe 2) at least two of these receiving means (26a; 26b) as well as a diffusing element 5 (having the characteristics described above) interposed between the sample E and the contact surface 22.

According to a first type of embodiment (not shown), the probe 2 of a spectroscopy device 1 (with or without a diffusing element 5) includes at least two superimposed receiving means (26a; 26b) extending in a direction substantially perpendicular to the incident light.

In this respect, it should be noted that, in this case, a first receiving means 26a can be of a reflecting type and be formed either by a polished portion of the material (preferably stainless steel) the probe 2 is formed of at the level of the contact surface 22 or by a white portion of this contact surface 22.

A second receiving means 26b can then consist of a material capable of changing its optical properties under the action of an external parameter.

Such a material can then be applied on the first receiving means 26a (and, hence, namely to the polished material the probe 2 is formed of) and be designed capable of changing its level of absorption of the re-emitted light, this under the action of an electric current.

Such a material can consist of liquid crystals or a film, a coating or a layer (in particular a polymeric coating) containing such liquid crystals.

In such a case, these two receiving means (26a; 26b) are each associated to all the collecting means 24, even (and preferably) to all the illuminating means 23.

However and according to a second type of embodiment shown in FIGS. 5 and 6, the probe 2 of a spectroscopy device 1 (with or without a diffusing element 5) includes at least two juxtaposed receiving means (26a; 26b) extending in a direction substantially perpendicular to the incident light.

In such a case, each of these receiving means (26a; 26b) is associated to part of the collecting means 24, even (and preferably) to part of the illuminating means 23.

According to another feature, at least one receiving means (26a; 26b) can be of a reflecting type and be defined at the level of at least one portion of the contact surface 22.

A particular embodiment consists in that each of these receiving means (26a; 26b) is of a reflecting type, but has a different reflection index.

However and according to a preferred embodiment, only one of these receiving means (26a; 26b) is of a reflecting type.

Irrespective of the embodiment considered, such a receiving means (26a; 26b) of a reflecting type has the above-mentioned characteristics (polished or white portion of the contact surface 22 or reflecting coating).

According to still another feature, at least one receiving means (26a; 26b) can be of an absorbing type and be defined at the level of at least one portion of the contact surface 22.

A particular embodiment consists in that each of these receiving means (26a; 26b) can then be of the absorbing type, but has a different absorption index (in particular due to a color, a color shade or a different intensity of color).

However and according to a preferred embodiment, only one of these receiving means (26a; 26b) is of an absorbing type.

Irrespective of the embodiment considered, such a receiving means (26a; 26b) of an absorbing type has the above-mentioned characteristics (colored material the probe 2 is formed of or colored coating applied on the material the probe 2 is formed of).

Yet another feature consists in that at least one receiving means (26a; 26b) can be of a diffusing type and be defined at the level of at least one portion of the contact surface 22.

A particular embodiment consists in that each of these receiving means (26a; 26b) can then be of the diffusing type, but has a different diffusion index.

However and according to a preferred embodiment, only one of these receiving means (26a; 26b) is of a diffusing type.

Irrespective of the embodiment considered, such a receiving means (26a; 26b) of a diffusing type has the above-mentioned characteristics (surface conditions provided by physical and/or chemical treatment or by the applied diffusing coating).

Finally, at least one receiving means (26a; 26b) can consist of a material (applied on the material the probe 2 is formed of) capable of changing the optical properties (in particular of changing its level of absorption of the re-emitted light) under the action of an external parameter (in particular under the action of an electric current).

Here too, such a material capable of changing the optical properties can consist of liquid crystals.

A particular embodiment consists in that each of these receiving means (26a; 26b) can then consist of such a material, but has a different diffusion index.

However and according to a preferred embodiment, only one of these receiving means (26a; 26b) may consist of such a material.

In FIGS. 5 and 6 is shown a preferred embodiment of the invention corresponding to a spectroscopy device 1 including, on the one hand, a receiving means 26a of the reflecting type, in particular formed of a polished portion of the contact surface 22 of the probe 2 (preferably made of stainless steel) and, on the other hand, a receiving means 26b of the absorbent type, in particular formed of a colored coating (in particular a paint of black color) a portion of the contact surface includes and which is applied on the material the probe 2 is formed of.

As mentioned above, the spectroscopy probe 2 includes illuminating means 23 including, at the level of the contact surface 22, at least one optical fiber 230 or a plurality of optical fibers 230, in particular grouped within at least one bundle 231 of optical fibers 230.

Likewise, this probe 2 includes collecting means 24 including, at the level of the contact surface 22, at least one optical fiber (240a; 240b; 240c) or a plurality of optical fibers (240a; 240b; 240c), in particular grouped within at least one series (241a; 241b; 241c) of optical fibers (240a; 240b; 240c).

According to another feature of the invention, the means 24 for collecting the re-emitted light include, in fact and at the level of the contact surface 22, on the one hand, a first part (24a) of these collecting means 24 formed of at least one optical fiber 240a or (and preferably) at least one series 241a of optical fibers 240a and, on the other hand, at least a second part (24b) of these collecting means 24 formed of at least one optical fiber 240b or at least one series 241b of optical fibers 240b.

An additional feature consists in that the first part (24a) of the collecting means 24 (i.e. the fibers 240a, or also the series 241a of fibers 240a of this first 24a part) and the second part (24b) of the collecting means 24 (i.e. the fibers 240b or also the series 241b of fibers 240b of this second 24b part) are positioned on both sides of the means 23 in order to illuminate the sample.

Yet another feature consists in that, on the one hand, the fiber 240a or the barycenter of at least one series 241a of fibers 240a of the first part 24a of the collecting means 24 and, on the other hand, the fiber 240b or the barycenter of at least one series 241b of fibers 240b of at least the second part 24b of the collecting means 24, are aligned between them (240a, 240b; 241a, 241b) on the barycenter of the contact surface 22 and/or on the barycenter of the means 23 in order to illuminate the sample E.

According to another feature:

on the one hand, the optical fiber (240a) or the optical fibers (240a) [namely of at least one series (241a) of optical fibers (240a)] the first part (24a) of the collecting means (24) includes are located at a first distance from the means (23) in order to illuminate the sample or from the barycenter of these illuminating means (23);

in addition, the optical fiber (240b) or the optical fibers (240b) [namely of at least one series (241b) of optical fibers (240b)] the second part (24b) of the collecting means (24) includes are located at a second distance of the means in order to illuminate the sample or from the barycenter of these illuminating means (23).

According to a first embodiment, these first and second distances are different, which will permit, advantageously and as described below, to determine the intensity Io of the light source as well as the diffusion coefficient μs′ and the absorption coefficient μa.

According to a second embodiment, these first and second distances are equal, which advantageously permits to determine the homogeneity of a mixture the sample to be analyzed is comprised of.

In such a case, on the one hand, the optical fiber (240a) or the optical fibers (240a [namely of at least one series (241a) of optical fibers (240a)] the first part (24a) of the collecting means (24) includes and, on the other hand, the optical fiber (240b) or optical fibers (240b) [namely of at least one series (241b) of optical fibers (240b)] the second part (24b) of the collecting means (24) includes are positioned at the same distance from the means (23) in order to illuminate the sample (E) or from their barycenter and/or are arranged on a circle the center of which coincides with these means (23) in order to illuminate the sample (E) or with their barycenter.

In this respect, it should be noted that a particular embodiment consists in that the device then comprises a plurality of fibers (240a; 240b) or a plurality of series (241a; 241b) of fibers (240a; 240b) arranged on such a circle or a plurality of circles of this type.

As an alternative or additionally, on the one hand, the fiber 240a or the barycenter of at least one series 241a of fibers 240a of the first part 24a of the collecting means 24 and, on the other hand, the fiber 240b or the barycenter of at least one series 241b of fibers 240b of at least the second part 24b of the collecting means 24 are positioned symmetrically with respect to the barycenter of the contact surface 22 and/or with respect to the barycenter of the illuminating means 23.

Such an embodiment advantageously permits to evaluate the homogeneity of the powders or other turbid products.

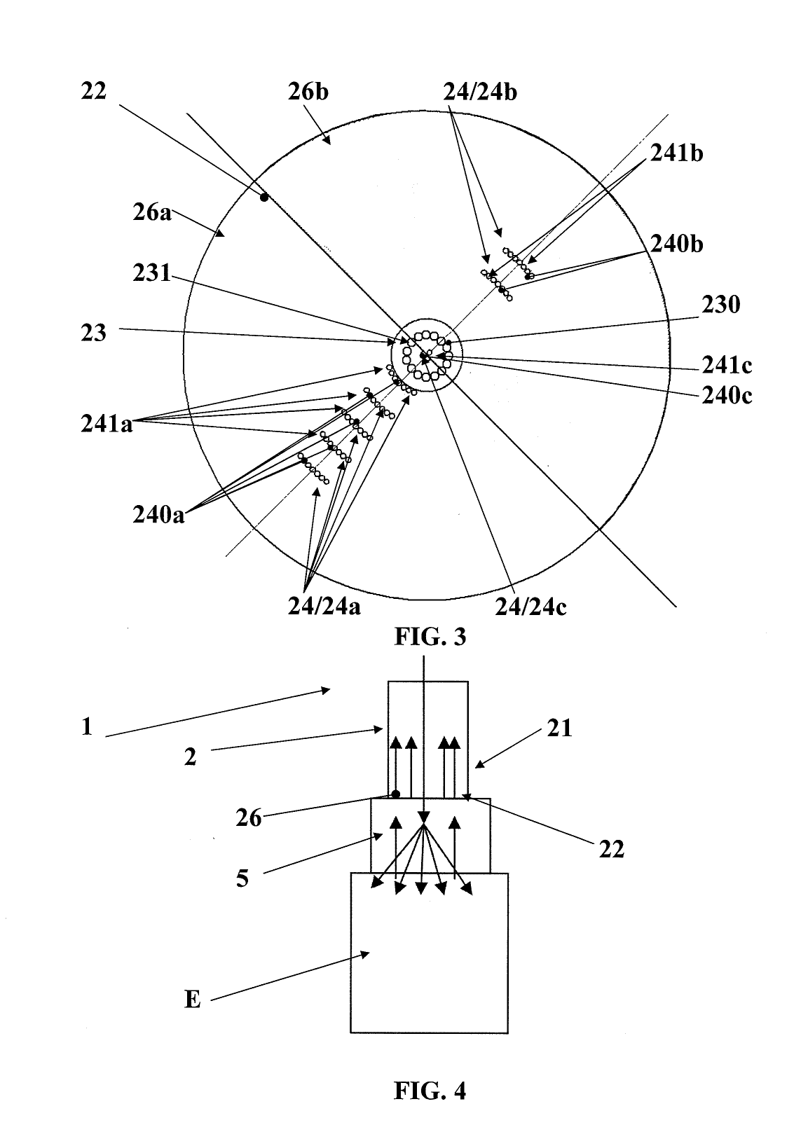

According to an additional feature, at least one series (241a; 241b; 241c) (preferably each series 241a; 241b; 241c) of optical fibers (240a; 240b; 240c) the collecting means 24 includes comprises a plurality of optical fibers (240a; 240b; 240c), in particular from 2 to 15 optical fibers (240a; 240; 240c), preferably about 8 optical fibers (240a; 240b; 240c), as shown in FIG. 3.

A preferred embodiment consists in that at least one series (241a; 241b; 241c) (preferably each series 241a; 241b; 241c) of optical fibers (240a; 240b; 240c) the collecting means 24 includes comprises a plurality of optical fibers (240a; 240b; 240c) arranged so as to be located at the same distance from the means 23 for illuminating the sample and/or from the barycenter of these illuminating means 23).

The optical fibers (240a; 240b; 240c) of these series (241a; 241b; 241c) of optical fibers (240a; 240b; 240c) are then, and preferably, arranged in juxtaposed and/or are positioned on an arc of a circle the center of which is formed by the illuminating means 23 or the barycenter of these illuminating means 23.

As mentioned above, the means 23 for illuminating the sample E include, at the level of the contact surface 22 (in particular centered with respect to this contact surface 22), at least one optical fiber 230 or at least one bundle 231 of optical fibers 230 comprised of at least two optical fibers 230.

According to a first embodiment, not shown, the means 23 for illuminating the sample E include at least one optical fiber 230 (preferably at least one bundle 231 of optical fibers 230) the barycenter of which preferably coincides with the barycenter of the contact surface 22.

In such a case, the device 1 can also include means 24 for collecting the re-emitted light including a series 241 of optical fibers 240 comprised of a plurality of optical fibers 240 positioned around, even at the periphery, of the optical fiber or fibers 230 of the illuminating means 23, in particular on a circle.

However and according to a preferred embodiment of the invention, the means 23 for illuminating the sample E include a plurality of optical fibers 230 arranged in the form of at least one bundle 231 of optical fibers 230.

A particular embodiment consists in that the optical fibers 230 of such a bundle 231 are then arranged (in particular juxtaposed) on at least one circle (shown in FIG. 3), at least one ring (several namely concentric lines or circles of fibers 230) or even so as to fill at least partly a disc. The fibers 231 of this or these bundles 231 then have a barycenter (namely corresponding to the center of the circle, the ring or the disc), preferably coinciding with the barycenter of the contact surface 22.

In such a case, the device 1 can also include collecting means 24c formed of at least one optical fiber 240c or at least one series 241c of optical fibers 240c, (in particular a series 241c of 3 optical fibers 240c, as can be seen in FIG. 3) positioned inside the circle or of the ring defined by the illuminating means 23, in particular in the center of this circle, the ring and/or at the barycenter of the illuminating means 23.

In this respect, it should be noted that the above-mentioned features are present in a probe 2 including one single receiving means 26, but also when the latter 2 includes at least two of these different receiving means (26a; 26b).

In particular, when such a probe 2 includes at least two different receiving means (26a; 26b), this probe 2 then includes, on the one hand, a first part 24a of the collecting means 24 associated to a first receiving means 26a and, on the other hand, at least a second part 24b of these collecting means 24 associated to at least a second receiving means 26b.

Such an embodiment advantageously permits to carry out a measurement of the spectral signal at the level of the different receiving means (26a; 26b) and in areas (in particular at the boundaries of the collecting means 24) having a different index. This permits, in fact, to measure, for one and the same sample, the changes of a spectral signal with respect to the changes caused by the differences in optical properties of these areas with different optical (reflecting, absorbent and/or diffusing) characteristics.

It is more specifically such a type of measurement that permits to generate the above-mentioned third dimension, which advantageously permits to determine the intensity Io of the light source as well as the diffusion coefficient μs′ and the absorption coefficient μa.

As mentioned above, the probe 2 includes, on the one hand, a first part 24a of the collecting means 24 associated to a first receiving means 26a and, on the other hand, at least a second part 24b of these collecting means 24 associated to at least a second receiving means 26b.

In this respect and according to an additional feature, the first part 24a of these collecting means 24 includes from 2 to 8 (and preferably 5, as can be seen in FIG. 3) series 241a of optical fibers 240a.

This first part 24a of the collecting means 24 is preferably associated to a receiving means 26a of the reflecting type having the above-described features (in particular in the form of a polished or white contact surface 22).

According to another additional feature, the second part 24b of the collecting means 24 includes at least one (and preferably two, as can be seen in FIG. 3) series 241b of optical fibers 240b.

This second part 24b of the collecting means 24 is preferably associated to a receiving means 26b of the absorbent type having the above-described characteristics (in particular in the form of a colored coating, in particular a black paint).

Another feature consists in that at least the optical fibers (240a; 240b; 240c) of the collecting means 24 (even those 230 of the illuminating means 23) have, on the one hand, a first end associated to the contact surface 22 (in particular through the through openings 25) and, on the other hand, a second end associated to the means 3 for measuring and/or processing the optical signal re-emitted by the sample and collected by these collecting means 24.

According to a first embodiment, this second end of the fibers (230; 240a; 240b; 240c) can be associated to a multiplexer connected, on the one hand, to these fibers (230; 240a; 240b; 240c) and, on the other hand, to a measuring instrument (in particular including such a multiplexer) forming at least partly such a signal-measuring and/or processing means 3.

A second embodiment consists in that this second end of the fibers (230; 240a; 240b; 240c) is placed in front of several photodiodes (whether provided or not with a filter) such a signal-measuring and/or processing means 3 includes.

Finally and according to a preferred embodiment of the invention, this second end of the fibers (230; 240a; 240b; 240c) is connected to a (multi-input or traditional) spectrometer forming at least partly such a signal-measuring and/or processing means 3.

An additional feature consists in that the second end of the optical fibers 230 (in particular entering into the composition of a bundle 231 of optical fibers 230) of the illuminating means 23 is associated to a connector 40 the connecting means 4 includes and into which 40 the end of this or these fibers 230 is preferably embedded.

In addition, the second end of the optical fibers (240a; 240b; 240c) entering into the composition of one and the same series (241a; 241b; 241c) of fibers (240a; 240b; 240c) of the collecting means 24 is associated to a connector (41a; 41b; 41c) the connecting means 4 includes and in which (41a; 41b; 41c) the end of these fibers (240a; 240b; 240c) is preferably embedded.

In fact, such a connector (40; 41a; 41b; 41c) is then connected to the above-mentioned measuring and/or processing means 3.

A preferred embodiment consists in that such a connector (40; 41a; 41b; 41c) is of the SMA type.

The invention also relates to a method for analyzing a sample E by spectroscopy.

This method is in particular implemented by means of the device 1 having the above-described features.

This method for analyzing consists in that:

the sample E is illuminated by incident light and by means of at least one illuminating means 23;

the light re-emitted by the sample E is received by means of at least one receiving means (26; 26a; 26b);

the light re-emitted by the sample E is collected by means of collecting means 24, this at the level of or near at least one receiving means (26; 26a; 26b).

This method is characterized in that:

the sample E is illuminated by incident light, this through a diffusing element 5 and/or;

the light re-emitted by the sample E is collected at the level of at least two different receiving means (26a; 26b), each, on the one hand, having a different absorption, reflection and/or diffusion index and, on the other hand, receiving, at its level or close to it, at least part of the collecting means 24;

at least one property of the sample to be analyzed is determined based on the light re-emitted and collected by the collecting means 24, this at the level of this or these receiving means (26a; 26b).

According to a first embodiment (shown in FIG. 4), the sample E is illuminated by incident light, this through a diffusing element 5, and the light re-emitted by the sample E is collected at the level of one single receiving means 26 receiving, at its level or close to it, at least part of the (even the entire) collecting means 24.

In this case, the diffusing element 5 is interposed between the sample E to be analyzed and the contact surface 22 of the probe 2 (in particular into contact with this diffusing element 5).

According to a second embodiment (shown in FIG. 5), the sample E is illuminated by incident light (in the absence of any diffusing element 5 whatsoever) and the light re-emitted by the sample E is collected at the level of at least two different receiving means (26a; 26b), each, on the one hand, having a different absorption, reflection and/or diffusion index and, on the other hand, receiving, at its level or close to it, part (24a; 24b) of the collecting means 24.

In this case, the contact surface 22 of the probe 2 is directly into contact with the sample E to be analyzed.

Finally and according to a third embodiment (shown in FIG. 6), the sample E is illuminated with incident light, this through a diffusing element 5 and the light re-emitted by the sample E is collected at the level of at least two different receiving means (26a; 26b), each, on the one hand, having a different absorption, reflection and/or diffusion index and, on the other hand, receiving, at its level or close to it, part (24a; 24b) of the collecting means 24.

Here too, the diffusing element 5 is interposed between the sample E to be analyzed and the contact surface 22 of the probe 2 (in particular into contact with this diffusing element 5).

This method also consists in that the light re-emitted by the sample E is collected by collecting means 24 positioned at a given distance from the illuminating means 23.

In particular, this distance can be different for each collecting means 24 and/or each series (21a; 241b; 241c) of collecting means 24.

In particular, the light re-emitted by the sample E is collected by collecting means 24 formed of optical fibers (240a; 240b; 240c) or by series (241a; 241b; 241c) of optical fibers (240a; 240b; 240c) positioned at a given distance from the illuminating means 23, in particular at a distance from these illuminating means 23 different for each fiber (240a; 240b; 240c) and/or for each series (241a; 241b; 241c) of fibers (240a; 240b; 240c).

This advantageously permits to determine a property of the sample corresponding to the absorption coefficient (μa) and/or the diffusion coefficient (μs′) of this sample (E).

This process then consists in particular in that:

the light re-emitted by the sample (E) is collected, on the one hand, by a first part (24a) of the collecting means (24) located at a first distance from the illuminating means (23) and, on the other hand, by a second part (24b) of the collecting means (24) located at a second distance from these illuminating means (23), different from the first distance;

based on the light re-emitted and collected by the first (24a) and the second (24b) part of the collecting means (24) is determined a property of the sample corresponding to the absorption coefficient (μa) and/or the diffusion coefficient (μs′) of this sample (E).

However and according to another embodiment, this method consists in that the light re-emitted by a collecting means 24 [optical fibers (240a; 240b) or series (241a; 241b) of optical fibers (240a; 240b)] positioned at the same distance from the illuminating means 23 and/or the barycenter of these illuminating means 23, in particular on a circle the center of which coincides with these means (23) for illuminating the sample (E) or with their barycenter, is collected.

This advantageously permits to determine a property of the sample corresponding to the homogeneity of this sample (E).

In particular, this method consists in that:

the light re-emitted by the sample (E) is collected, on the one hand, by a first part (24a) of the collecting means (24) and, on the other hand, by a second part (24b) of the collecting means (24) located at the same distance from the illuminating means (23) as the first part (24a) of these collecting means (24);

based on the light re-emitted and collected by the first (24a) and the second (24b) part of the collecting means (24) is determined a property of the sample corresponding to the homogeneity of this sample (E).

In particular, the light re-emitted by collecting means 24 [optical fibers (240a; 240b) or series (241a; 241b) of optical fibers (240a; 240b)] positioned symmetrically with respect to the illuminating means 23 and/or the barycenter of these illuminating means 23 is collected.

This method then consists in particular in collecting the light re-emitted by a sample E to be analyzed:

at different distances from the incident light;

in areas having different optical properties (due to receiving means (26a, 26b) having a different absorption, reflection and/or diffusion index).

This method therefore permits to measure an optical spectral signal, which depends on the distance with respect to the incident light as well as on the changes caused by the varying optical properties of the probe 2.

In particular, this method consists in measuring such a signal by means of a probe 2 the contact surface 22 of which includes at least two different receiving means (26a; 26b) (either by modifying part of the contact surface 22, or by using a material capable of changing its optical properties, as mentioned above) and which does therefore not have a uniform optical property.

This method therefore permits to measure, on the one hand, part of the SRS signal under certain optical conditions (in particular under reflecting conditions) and, on the other hand, another part of the SRS signal under different conditions (in particular under absorbent conditions).

Under these conditions, two systems of equations depending on the conditions at the boundaries are applicable, one of which (1) was mentioned above, while the other one (3) reads as follows:

$$R ( ρ ) = \frac{{I}_{0 a}}{4 π} [ \begin{matrix}\frac{1}{{μ}_{tr}} ( {μ}_{eff} + \frac{1}{{r}_{1}} ) \frac{exp ( - {μ}_{eff} {r}_{1} )}{{r}_{1}^{2}} + \\ ( \frac{1}{{μ}_{tr}} + 2 {z}_{b} ) ( {μ}_{eff} + \frac{1}{{r}_{2}} ) \frac{exp ( - {μ}_{eff} {r}_{2} )}{{r}_{2}^{2}}\end{matrix} ] \qquad ( 3 )$$

wherein:

μ_{eff}=[3μₐ(μₐ+μₛ′)]⁻¹

a=μₛ′/μₜᵣ

r₁=[z₀²+ρ²]^{1/2}

r₂=[(z₀+2z_{b})²+ρ²]^{1/2}

z⁰=1/μₛ′

z_{b}=2AD

wherein:

D is the diffusion coefficient (depending on μa and μs′);

A is a parameter, which, on the one hand, is invariable during one and the same measurement and, on the other hand, permits to take into consideration the difference in refraction index at the surface of the medium.

This results into the fact that, for the same measurement performed under different optical conditions (as in the case of this invention), this parameter A then influences R(ρ), which, for a given wavelength λ, then also depends on A and becomes R(ρ, A).

When also taking into consideration the spectral dimension (in particular the wavelength λ of the incident light), the generated spectral signal is certainly three-dimensional: R(ρ, λ, A).

The method according to the present invention thus results into generating a spectral signal in 3 dimensions permitting advantageously:

to determine the intensity of the light source I0 and, hence, the diffusion coefficient μs′ and absorption coefficient μa;

to detect the presence of layers in the sample E;

to highlight a phenomenon of fluorescence;

to improve the quality of the signal;

to allow the evaluation of very absorbent samples.

The method according to the present invention consists, after having measured the spectral signal, in that this signal is processed in order to obtain the properties of the sample E.

In fact, such a processing of the signal can be ensured by traditional methods such as Montecarlo simulation, calculation by finite elements and/or the inverse problem.

However and according to another feature of the invention, in addition to the processing by such a traditional method, the process can also consist in that the signal is directly processed in 2 dimensions (SRS) or the signal is directly processed in 3 dimensions (SRS and change of optical conditions).

According to a first embodiment, the direct processing of such a signal (2D or 3D) consists in an approach by modeling.

In this first embodiment, a look-ahead model of at least one target property (particle sizes, concentration, uniformity . . . ) is established, this based on the PLS (partial Least Squares) or SVM (support vector machine). Multi-way methods such as PARAFAC (parallel Factor analysis) or N-PLS can also be used.

However and according to a second embodiment, the direct processing of such a signal (2D or 3D) consists in that a synthesis-spectra bank is first of all generated and in that this synthesis-spectra bank is then used to calibrate a look-ahead model of at least one target property looked for of the sample E.

In this respect, it should be noted that, when a synthesis-spectra bank is generated, virtual measurements of all the possible types of samples (variation of μs′ and μa) are actually generated, this by using in particular optical-simulation software for a diffusing medium.

It should be noted that the generation of this synthesis-spectra bank can occur without a priori knowledge. In this case, a scheme of experiments should be set up in order to determine the optimal changes of μa and μs′, this in order to obtain the best basis for calibration by simulation.

However, the generation of this synthesis-spectra bank can also occur with a priori knowledge.

In such a case:

spectra corresponding to various chemicals in a pure state are measured;

the possible physical properties, in particular the changes of the possible diffusion (μs′), the possible layer size and thickness, the shape of the sample (spherical, cylindrical . . . ) . . . are evaluated.

these data are combined by means of a scheme of experiments in order to generate (in particular via simulation by finite elements) synthesis spectra.

In this case, it is also possible, in a complementary way, to integrate disturbing phenomena by measuring the spectrum of at least some of these chemicals under various experimental conditions.

Such a perturbing phenomenon can, by way of an example and without being restrictive at all, be formed by the temperature.

As evoked above, the second embodiment of the direct processing of a signal (2D or 3D) consists in that the synthesis-spectra bank is used to calibrate a look-ahead model of at least one target property looked for of the sample E.

In this respect, it should be noted that such a look-ahead model can then be calibrated via MLR (multi-linear regression), PLS or SVM.

Advantageously, this synthesis-spectra bank can be used to calibrate a look-ahead model of the property of interest, which can be:

one or more optical coefficients;

one or more physical parameters (particle size, thickness of layers, Carr Index, density . . . );

one or more chemical parameters (concentrations of active substance, sugar, anthocyans,

According to another advantage of this second embodiment, it has the advantage of gaining in speed when the target properties of a sample E are to be determined.

1. Spectroscopy device (1) for analyzing a sample (E) by spectroscopy and including at least one spectroscopic probe (2) provided with:
means (23) for illuminating the sample (E) to be analyzed with incident light;
means (24) for collecting light re-emitted by the sample (E) to be analyzed under the action of the incident light;
a contact surface (22), on the one hand, oriented towards the sample (E) to be analyzed, on the other hand, at the level of or near which (22) the illuminating means (23) and/or the collecting means (24) are located and, yet on the other hand, including at least one means (26; 26a; 26b) for receiving the light re-emitted by the sample (E);
wherein:
the probe (2) includes at least two different receiving means (26a; 26b), on the one hand, which the contact surface (22) includes, on the other hand, having each (26a; 26b) a different absorption, reflection and/or diffusion index and, yet on the one hand, each (26a; 26b) associated to at least part of the collecting means (24), and/or;
the device (1) also includes an element (5) interposed between the contact surface (22) and the sample (E) to be analyzed, and designed to diffuse at least the incident light.

2. Spectroscopy device (1) according to claim 1, wherein at least one receiving means (26; 26a; 26b) is of a reflecting type and is defined at the level of at least one portion of the contact surface (22) of the probe (2).

3. Spectroscopy device (1) according to claim 2, wherein the receiving means (26; 26a; 26b) of a reflecting type is formed of either a polished or white portion of the contact surface (22) of the probe (2) or a reflecting coating a portion of the contact surface (22) of the probe (2) includes.

4. Spectroscopy device (1) according to claim 1, wherein at least one receiving means (26; 26a; 26b) is of an absorbing type and is defined at the level of at least one portion of the contact surface (22) of the probe (2).

5. Spectroscopy device (1) according to claim 4, wherein the receiving means (26; 26a; 26b) of an absorbing type is formed of either a colored material forming a portion of the contact surface (22) of the probe (2) or a colored coating a portion of the contact surface (22) of the probe (2) includes.

6. Spectroscopy device (1) according to claim 1, wherein at least one receiving means (26; 26a; 26b) is of a diffusing type and is defined at the level of at least one portion of the contact surface (22) of the probe (2).

7. Spectroscopy device (1) according to claim 6, wherein the receiving means (26; 26a; 26b) of a diffusing type is formed of either a diffusing coating a portion of the contact surface (22) of the probe (2) includes or a surface condition having asperities and a portion of the contact surface (22) of the probe (2) includes.

8. Spectroscopy device (1) according to claim 1, wherein at least one receiving means (26; 26a; 26b) is formed of a material capable of changing its optical properties under the action of an external parameter.

9. Spectroscopy device (1) according to claim 3, wherein the coating the contact surface (22) includes is formed of a chemical and/or physical deposition, a paint, a film, a polymer layer or the like.

10. Spectroscopy device (1) according to claim 1, wherein the spectroscopy device (1) includes, on the one hand, a receiving means (26a) of the reflecting type, in particular formed of a polished portion of the contact surface (22) of the probe (2) and, on the other hand, a receiving means (26b) of the absorbent type, in particular formed of a colored coating a portion of the contact surface (22) includes and which is applied on the material the probe (2) is formed of.

11. Spectroscopy device (1) according to claim 1, wherein the means (23) for illuminating the sample include, at the level of the contact surface (22), at least one optical fiber (230) or at least one bundle (231) of optical fibers (230) formed of at least two optical fibers (230).

12. Spectroscopy device (1) according to claim 1, wherein the means (24) for collecting the re-emitted light include, at the level of the contact surface (22), on the one hand, a first part (24a) of these collecting means (24) formed of at least one optical fiber (240a) or of at least one series (241a) of optical fibers (240a) and, on the other hand, at least a second part (24b) of these collecting means (24) formed of at least one optical fiber (240b) or at least one series (241b) of optical fibers (240b).

13. Spectroscopy device (1) according to claim 12, wherein the first part (24a) of the collecting means (24) and the second part (24b) of the collecting means (24) are positioned on both sides of the means (23) for illuminating the sample.

14. Spectroscopy device (1) according to claim 12, wherein, on the one hand, the fiber (240a) or the barycenter of at least one series (241a) of fibers (240a) of the first part (24a) of the collecting means (24) and, on the other hand, the fiber (240b) or the barycenter of at least one series (241b) of fibers (240b) of at least the second part (24b) of the collecting means (24) are aligned between them (240a, 240b; 241a, 241b) on the barycenter of the contact surface (22) and/or on the barycenter of the means (23) in order to illuminate the sample (E), and or positioned symmetrically with respect to the barycenter of the illuminating means (23).

15. Spectroscopy device (1) according to claim 12, wherein:
on the one hand, the optical fiber (240a) or optical fibers (240a), namely of at least one series (241a) of optical fibers (240a) the first part (24a) of the collecting means (24) includes;
on the other hand, the optical fiber (240b) or optical fibers (240b), namely of at least one series (241b) of optical fibers (240b) the second part (24b) of the collecting means (24) includes;
are positioned at the same distance from the means (23) for illuminating the sample (E) or from their barycenter and/or are arranged on a circle the center of which coincides with these means (23) for illuminating the sample (E) or with their barycenter.

16. Spectroscopy device (1) according to claim 12, wherein:
on the one hand, the optical fiber (240a) or optical fibers (240a), namely of at least one series (241a) of optical fibers (240a) the first part (24a) of the collecting means (24) includes are located at a first distance from the illuminating means (23);
on the other hand, the optical fiber (240b) or optical fibers (240b), namely of at least one series (241b) of optical fibers (240b) the second part (24b) of the collecting means (24) includes are located at a second distance from these illuminating means (23), different from the first distance.

17. Spectroscopy device (1) according to claim 12, wherein at least one series (241a; 241b) optical fibers (240a; 240b) the collecting means (24) includes a plurality of optical fiber (240a; 240b) arranged so as to be located at the same distance from the means for illuminating the sample (23) and/or from the barycenter of these illuminating means (23).

18. Spectroscopy device (1) according to claim 1, wherein the means (23) for illuminating the sample (E) are formed of at least one bundle (231) of optical fibers (230) including a plurality of optical fiber (230) arranged on at least one circle or at least one ring, while the spectroscopy device (1) can also include collecting means (24c) formed of at least one optical fiber (240c) or at least one series (241c) of optical fibers (240c) positioned inside the circle or the ring of the illuminating means (23), in particular at the center of this circle, of this ring and/or at the barycenter of the illuminating means (23).

19. Spectroscopy device (1) according to claim 12, wherein the probe (2) includes at least two different receiving means (26a;
26b) and, on the one hand, a first part (24a) of the collecting means (24) is associated to a first receiving means (26a) and, on the other hand, at least a second part (24b) of these collecting means (24) is associated to at least a second receiving means (26b).

20. Spectroscopy device (1) according to claim 19, wherein the first part (24a) of the means (24) for collecting the light is associated to a receiving means (26a) of the reflecting type and includes from 2 to 8 series (241a) of optical fibers (240a), while the second part (24b) of the means (24) for collecting the light is associated to a receiving means (26b) of the absorbing type and includes at least one series (241b) of optical fibers (240b).

21. Spectroscopy device (1) according to claim 1, wherein the free end of the probe (2) includes, on the one hand, the contact surface (22) and, on the other hand, a plurality of through openings (25) emerging at the level of the contact surface (22) and receiving, namely internally and emerging at the level of this contact surface (22), the illuminating means (23) as well as the collecting means (24).

22. Method for analyzing a sample (E) by spectroscopy consisting in that:
the sample (E) is illuminated with incident light and by means of at least one illuminating means (23);
the light re-emitted by the sample (E) is received by means of at least one receiving means (26; 26a; 26b);
the light re-emitted by the sample (E) is collected by collecting means (24), this at the level of or near at least one receiving means (26; 26a; 26b),
wherein:
the sample (E) is illuminated with incident light, this through a diffusing element (5) and/or;
the light re-emitted by the sample (E) is collected at the level of at least two different receiving means (26a; 26b), which each, on the one hand, have a different absorption, reflection and/or diffusion index and, on the other hand, receive, at its level or close to it, at least part of the collecting means (24);
at least one property of the sample (E) to be analyzed is determined based on the light re-emitted and collected by the collecting means (24), this at the level of this or these receiving means (26a; 26b).

23. Method for analyzing according to claim 22, wherein the light re-emitted by the sample (E) is collected, on the one hand, by a first part (24a) of the collecting means (24) associated to a first receiving means (26a) of the reflecting type and, on the other hand, by at least a second part (24b) of these collecting means (24) associated to at least a second receiving means (26b) of the absorbing type.

24. Method for analyzing according to claim 22, wherein:
the light re-emitted by the sample (E) is collected, on the one hand, by a first part (24a) of the collecting means (24) and, on the other hand, by a second part (24b) of the collecting means (24) located at the same distance from the illuminating means (23) as the first part (24a) of these collecting means (24);
based on the light re-emitted and collected by the first (24a) and the second (24b) part of the collecting means (24) is determined a property of the sample corresponding to the homogeneity of this sample (E).

25. Method for analyzing according to claim 22, wherein:
the light re-emitted by the sample (E) is collected, on the one hand, by a first part (24a) of the collecting means (24) located at a first distance from the illuminating means (23) and, on the other hand, by a second part (24b) of the collecting means (24) located at a second distance from these illuminating means (23), different from the first distance;
based on the light re-emitted and collected by the first (24a) and the second (24b) part of the collecting means (24) is determined a property of the sample corresponding to the absorption coefficient (μa) and/or the diffusion coefficient (μs′) of this sample (E).
